(19) United States
(12) Patent Application Publication
(10) Pub. No.: US 2026/0178211 A1
(43) Pub. Date: Jun. 25, 2026

(54) DEBUG REPORTING BY A MEMORY SYSTEM

(71) Applicant: Micron Technology, Inc., Boise, ID (US)

(72) Inventors: Ming Ma, Shanghai (CN); Liang Ge, Shanghai (CN); Chaohui Liu, Shanghai (CN)

(21) Appl. No.: 19/397,628

(22) Filed: Nov. 21, 2025

Related U.S. Application Data
(60) Provisional application No. 63/737,158, filed on Dec. 20, 2024.

(51) Int. Cl. G06F 3/06

(52) U.S. Cl. CPC G06F 3/0653; G06F 3/0604; G06F 3/0679

(57) ABSTRACT

Methods, systems, and devices for debug reporting by a memory system are described. A memory system may implement a forward tracking debug solution (FSDS) for reporting information to a host system. According to the FSDS, the host system may perform periodic requests to request firmware log data after a duration from a previous request. The firmware log data may include one or more counters corresponding to occurrences of one or more critical events, such as read retry events and error handler events, among other examples. The memory system may maintain the one or more counters associated with the critical events and may adjust the counters in response to identifying the occurrence of a critical event. The memory system may transmit the values of the counters to the host system in response to receiving a checkpoint request, and may reset the counters after transmitting the counter values.

### CROSS REFERENCE

The present Application for Patent claims priority to U.S. patent application Ser. No. 63/737,158 by Ma et al., entitled “DEBUG REPORTING BY A MEMORY SYSTEM,” filed Dec. 20, 2024, which is assigned to the assignee hereof, and which is expressly incorporated by reference in its entirety herein.

### TECHNICAL FIELD

The following relates to one or more systems for memory, including debug reporting by a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports debug reporting by a memory system in accordance with examples as disclosed herein.

FIG. 2 shows an example of a process that supports debug reporting by a memory system in accordance with examples as disclosed herein.

FIG. 3 shows a block diagram of a memory system that supports debug reporting by a memory system in accordance with examples as disclosed herein.

FIG. 4 shows a flowchart illustrating a method or methods that support debug reporting by a memory system in accordance with examples as disclosed herein.

### DETAILED DESCRIPTION

Memory systems may be associated with various configurations for communicating or otherwise interfacing with a host system. In some configurations, a memory system may implement a backtracking system debug solution (BSDS) for reporting firmware information, such as firmware information associated with a universal flash storage (UFS) interface between the memory system and a host system. In accordance with the BSDS, the host system may identify relatively high latency events (e.g., an operation or type of operation executed at the memory system that takes a relatively long duration to complete) and may trigger a BSDS check to request firmware logs (e.g., backlogs) from the memory system in response to an event satisfying a latency threshold. In some cases, the memory system may maintain the firmware backlogs in UFS memory (e.g., NAND flash memory) and may store data associated with the events (e.g., a quantity of events, the types of events).

Accordingly, the BSDS may support the host system debugging latency-related errors or failures at the memory system by identifying the occurrences of high-latency events. However, the BSDS may not support or otherwise may limit the ability of the host system to analyze debug information and identify correlations between operations and memory system performance. For example, the host system may not identify a latency event for a relatively long duration (e.g., the memory system may not report a latency event for a relatively long duration), and the memory system may continue to store the firmware backlog data until an event (e.g., a latency event) that satisfies the threshold is observed by the host system (e.g., triggering the BSDS check). In such examples, due to the BSDS being trigger-based, events associated with a latency under but relatively close to the threshold latency may be reported relatively late and may be diluted by the relatively large amount of information reported in a single BSDS check.

Techniques described herein may provide for a memory system to implement a forward tracking debug solution (FSDS) for reporting information (e.g., debug data, debug statistics) to a host system. Using the FSDS, the host system may perform periodic requests, such that the host system sends the memory system requests for firmware backlog data at a configured (e.g., a defined) cadence. For example, the host system may configure a duration between checkpoint requests (e.g., 5 seconds) and may request the firmware backlog data after the duration from a previous request. The firmware backlog data may include one or more counters (or a value of one or more counters) corresponding to occurrences of one or more critical events. The critical events may include one or more memory system tasks or operations specified by the host system, the memory system, or both, such as read retry events and error handler events, among other examples.

The memory system may maintain the one or more counters associated with the critical events (e.g., respective counters for each event or each type of event or a single counter for all critical events) and may adjust (e.g., increment) the counters in response to identifying the occurrence of a critical event. The memory system may transmit the values of the counters to the host system in response to receiving a checkpoint request, and may reset the counters after transmitting the data (e.g., the counter values). The memory system may continue incrementing the counters and reporting the values between each FSDS checkpoint to inform the host system of the quantity of occurrences of critical events between checkpoint requests. Such techniques may allow the host system to analyze the memory system performance with increased granularity. For example, the FSDS implementation may support the host system identifying a correlation between host command latency and memory system firmware events (e.g., using large data models or AI accelerators), which may enable the host system to enhance future operations at the memory system.

In addition to applicability in memory systems as described herein, techniques for debug reporting may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by identifying correlations between device performance and types of commands executed over a duration, which may improve user experience, among other benefits.

Features of the disclosure are illustrated and described in the context of systems, devices, and circuits. Features of the disclosure are further illustrated and described in the context of a process, a block diagram, and a flowchart.

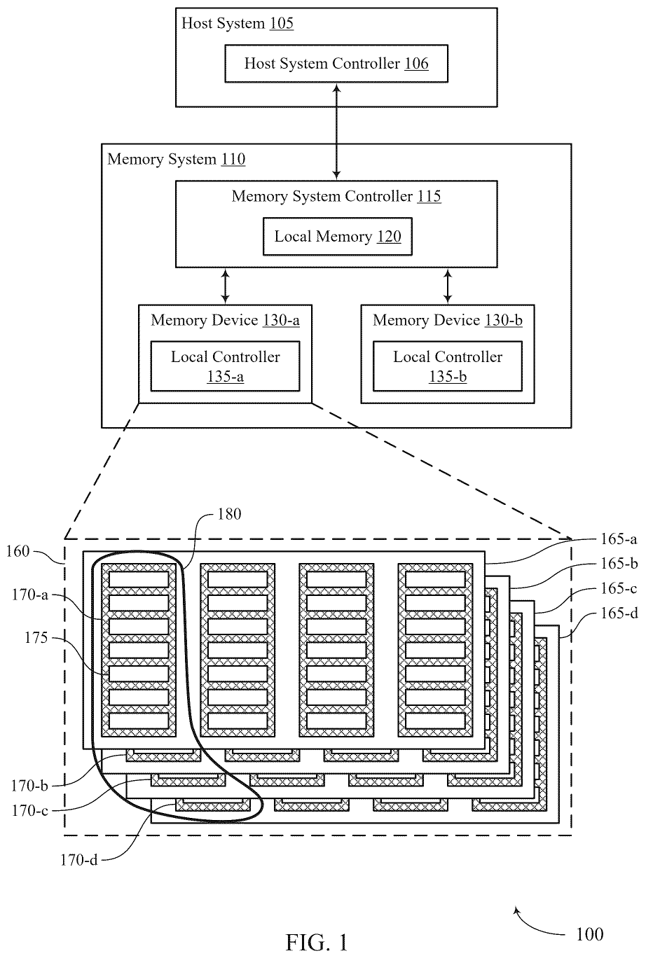

FIG. 1 shows an example of a system 100 that supports debug reporting by a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, a memory system 110 may implement a backtracking system debug solution (BSDS) for reporting firmware information, such as firmware information associated with a universal flash storage (UFS) interface between the memory system 110 and a host system 105. In accordance with the BSDS, the host system 105 may identify relatively high latency events (e.g., an operation or type of operation executed at the memory system 110 that takes a relatively long duration to complete) and may trigger a BSDS check to request firmware logs (e.g., backlogs) from the memory system 110 in response to an event satisfying a latency threshold. In some cases, the memory system 110 may maintain the firmware backlogs in UFS memory (e.g., NAND flash memory) and may store data associated with the events (e.g., a quantity of events, the types of events, or the like).

Thus, the BSDS may support the host system 105 debugging latency failure at the memory system 110 by identifying the occurrences of high-latency events. However, the BSDS may not support or otherwise may limit the ability of the host system 105 to analyze debug information at the memory system 110 to identify correlations between operations and memory system 110 performance. For example, the host system 105 may not identify a high latency event for a relatively long duration (e.g., the memory system 110 may not report a latency event for a relatively long duration), and the memory system 110 may continue to store the firmware backlog data for the duration until an latency satisfying the threshold is observed by the host system 105 (e.g., triggering the BSDS check). In such examples, due to the BSDS being trigger-based, events associated with a latency under but relatively close to the threshold latency may be reported relatively late and may be diluted by the relatively large amount of information reported in a single BSDS check.

Techniques described herein may provide for a memory system 110 to implement a forward tracking debug solution (FSDS) for reporting information (e.g., debug data, debug statistics) to a host system 105. Using the FSDS, the host system 105 may perform periodic requests, such that the host system 105 sends the memory system 110 requests for firmware backlog data at a configured (e.g., defined) cadence. For example, the host system 105 may configure a duration between checkpoint requests (e.g., 5 seconds) and may request the firmware backlog data after the duration from a previous request. The firmware backlog data may include one or more counters (or a value of one or more counters) corresponding to occurrences of one or more critical events. The critical events may include one or more memory system 110 tasks or operations specified by the host system 105, the memory system 110, or both, such as read retry events and error handler events, among other examples.

The memory system 110 may maintain the one or more counters associated with the critical events (e.g., respective counters for each event or each type of event or a single counter for all critical events) and may adjust (e.g., increment) the counters in response to identifying the occurrence of a critical event. The memory system 110 may transmit the values of the counters to the host system 105 in response to receiving a checkpoint request, and may reset the counters after transmitting the data (e.g., the counter values). The memory system 110 may continue incrementing the counters and reporting the values between each FSDS checkpoint to inform the host system 105 of the quantity of occurrences of critical events between checkpoint requests. Such techniques may allow the host system 105 to analyze the memory system 110 performance with increased granularity. For example, the FSDS implementation may support the host system 105 identifying a correlation between host command latency and memory system 110 firmware events (e.g., using large data models or AI accelerators), which may enable the host system to enhance future operations at the memory system 110.

The system 100 may include any quantity of non-transitory computer readable media that support debug reporting by a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

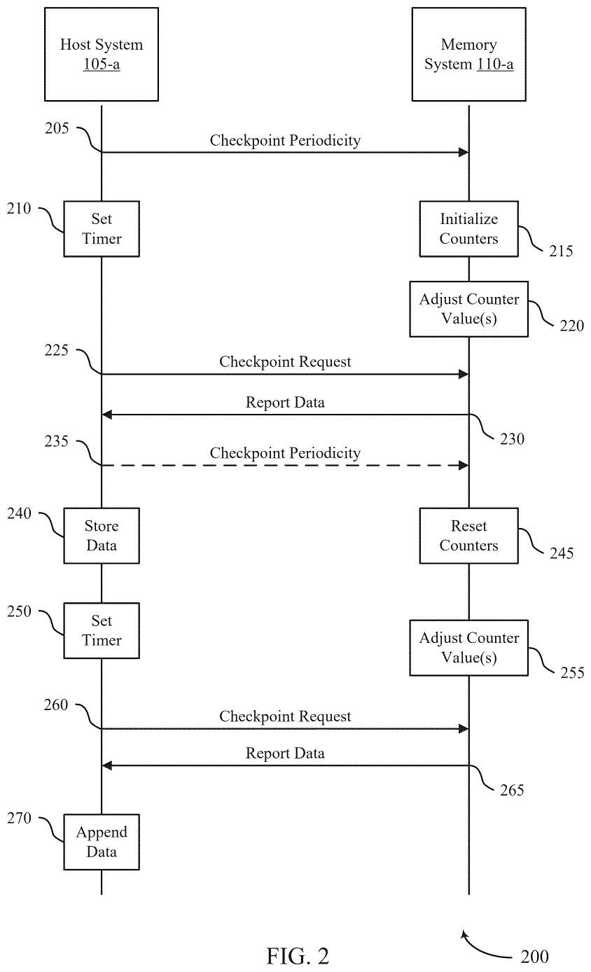

FIG. 2 shows an example of a process 200 that supports debug reporting by a memory system in accordance with examples as disclosed herein. The process 200 may implement, or be implemented by, one or more aspects of the system 100. For example, the process 200 illustrates signaling between a host system 105-a and a memory system 110-a, which may be examples of corresponding devices described with reference to FIG. 1. The process 200 may support the host system 105-a and the memory system 110-a implementing an FSDS for reporting data stored to one or more logs of the memory system 110-a (e.g., firmware backlogs, debug statistics), where the host system 105-a may request the data from the memory system 110-a periodically. Alternative examples of the following may be implemented, where some processes are performed in a different order than described or are not performed. In some cases, processes may include additional features not mentioned below, or further processes may be added.

Aspects of the process 200 may be implemented by one or more controllers, among other components. Additionally, or alternatively, aspects of the process 200 may be implemented as instructions stored in one or more memories (e.g., firmware stored in one or more memories coupled with the host system 105-a, the memory system 110-a, or both). For example, the instructions, when executed by one or more controllers (e.g., the host system controller 106 and/or the memory controller 115), may cause the one or more controllers (or a device or a system) to perform the operations of the process 200.

At 205, an indication of a periodicity may be communicated. For example, a memory system controller of the memory system 110-a (e.g., a memory system controller 115 described with reference to FIG. 1) may receive, from the host device, the indication of the periodicity. In some cases, the periodicity may be for reporting data stored to one or more logs of the memory system 110-a, and may be referred to as a checkpoint periodicity. As described herein, a checkpoint may be a time which the host system 105-a requests the data from the memory system 110-a. For example, the periodicity may be 5 seconds or 10 seconds, a quantity of milliseconds, a quantity of minutes, or any duration, among other examples. In some cases, the condition of the checkpoint periodicity may initiate a forward tracking system debug solution (FSDS) procedure, where the host system 105-a may request the data from the memory system 110-a according to the checkpoint periodicity (e.g., for a duration configured by the host system 105-a, such as via a daemon thread during night hours or other idle hours).

As described herein, the FSDS may be implemented in place of, or in addition to, a backtracking system debug solution (BSDS) for reporting log data, such as debug statistics. In the BSDS (which may be a feature of a UFS interface between the host system 105-a and the memory system 110-a), the host system 105-a may trigger a BSDS check if the host system 105-a observes relatively long latency (e.g., latency exceeding a threshold, such as 120 ms) for one or more commands executed by the memory system 110-a. The BSDS check may cause the memory system 110-a to transmit UFS firmware event and message backlogs from NAND flash memory to the host system 105-a.

In some examples, the firmware backlogs may be stored in a reserved area of the UFS memory according to a predefined size, which may be relatively large. For example, the memory system 110-a may record a large quantity of firmware events over a relatively long duration, such as if no events exceed the threshold latency and trigger a BSDS check by the host system 105-a. The BSDS may support the host system 105-a debugging latency issues (e.g., latency failure) at the memory system 110-a, due to the BSDS checks indicating events resulting in long latency. However, the BSDS may limit the ability of the host system 105-a to debug other issues or predict performance of the memory system 110-a using the event statistics. Techniques described herein provide for the host system 105-a and the memory system 110-a to utilize the FSDS, which may improve the debugging ability of the host system 105-a.

At 210, a timer may be set. For example, the host system 105-a may set a timer having a duration corresponding to the checkpoint periodicity (e.g., 5 seconds, 10 seconds, or another suitable duration). In some examples, the host system 105-a may be configured to transmit a checkpoint request to the memory system 110-a upon expiration of the timer.

At 215, one or more counters may be initialized. For example, the memory system 110-a may initialize the one or more counters (e.g., to begin tracking a respective value), and may set the counters to a starting value (e.g., 0). The one or more counters may be configured to track occurrences of one or more events at the memory system 110-a. Such events may be referred to as latency events or critical events, and may include one or more tasks, operations, commands, procedures, or any combination thereof performed at the memory system 110-a and specified by the host system 105-a, the memory system 110-a, or both. For example, critical events may include read retry events and error handler events, among other examples. The memory system 110-a may initialize the one or more counters in response to receiving the checkpoint periodicity, for example as part of initiating the FSDS procedure.

At 220, one or more counter values may be adjusted. For example, the memory system 110-a may adjust values of the one or more counters in response to determining an occurrence of the one or more latency events. In some cases, the memory system 110-a may maintain one counter for tracking occurrences of each of the one or more latency events, and may adjust (e.g., increment, for example by one) the counter for each occurrence of each of the one or more latency events. In other examples, the memory system 110-a may maintain a respective counter for each latency event or type of latency event. For example, the memory system 110-a may adjust a first counter in response to an occurrence of a first latency event or type of latency event (e.g., a read retry operation, read operations) and may adjust a second counter in response to an occurrence of a second latency event or type of latency event (e.g., an error handler event, write operations). Accordingly, the memory system 110-a may support the use of different counters for each type of operation performed.

The memory system 110-a may continue to adjust the values of the one or more counters in response to occurrences of the one or more latency events, for example during the duration the timer is running at the host system 105-a and prior to receiving a checkpoint request in accordance with the configured periodicity. In some examples, a counter of the one or more counters may reach an overflow value (e.g., 0xFFFF), which may be pre-defined by the host system 105-a. In such examples, the memory system 110-a may maintain the counter at the overflow value (e.g., even if the memory system 110-a identifies another occurrence of a latency event associated with the counter).

At 225, a checkpoint request may be communicated. For example, the host system 105-a may transmit the checkpoint request to the memory system 110-a. In some cases, the host system 105-a may transmit the checkpoint request in response to the timer (e.g., set at 210) expiring, which may correspond to a periodic occurrence of the checkpoint request. The checkpoint request may include a command for the memory system 110-a to transmit the data stored to the one or more logs of the memory system 110-a. For example, the data may include the values of the one or more counters, and the checkpoint request may request the values of the one or more counters from the memory system 110-a. In some cases, the checkpoint request may be an example of a vendor unique command.

At 230, data may be reported. For example, the memory system 110-a may transmit the data stored to the one or more logs of the memory system in response to the checkpoint request and in accordance with the periodicity. The data may include the values of the one or more counters, and may be an example of debug information for the memory system that is associated with the one or more latency events. In some cases, the report may be an example of a vendor unique message.

At 235, an indication of a second periodicity may be communicated. For example, the host system 105-a may transmit the indication of the second periodicity to the memory system 110-a, where the second periodicity may be for reporting the data stored to the one or more logs of the memory system. In some cases, the second periodicity may be different than the periodicity previously indicated (e.g., at 205) and may replace the periodicity for subsequent checkpoint requests.

At 240, data may be stored. For example, the host system 105-a may save the data reported by the memory system 110-a at 230. In some cases, storing the data may support the host system 105-a debugging the memory system 110-a or identifying correlations at the memory system 110-a. For example, using the values of the counters and latency trends observed between checkpoint requests, the host system 105-a may identify a correlation between command latency and device firmware events (e.g., using large data models or artificial intelligence (AI) accelerators). Accordingly, the FSDS may support the host system 105-a identifying mid-ranged latency events (e.g., events having a latency less than but relatively near the BSDS latency threshold) between checkpoint requests and correlating the mid-ranged latency events with the critical events at the firmware of the memory system 110-a (e.g., the host system 105-a may obtain a more detailed distribution of UFS latency and firmware events to learn for future optimizations).

At 245, one or more counters may be reset. For example, the memory system 110-a may reset the values of the one or more counters to a default or initial value (e.g., 0). The memory system 110-a may reset the values of the one or more counters in response to reporting the data at 230, which may support the memory system 110-a generating statistics for a second FSDS checkpoint.

At 250, a timer may be set. For example, the host system 105-a may initiate the timer associated with the checkpoint periodicity. A duration of the timer may correspond to a current periodicity, such as the periodicity initially configured by the host system 105-a or the second periodicity indicated between FSDS checkpoints.

At 255, one or more counter values may be adjusted. For example, the memory system 110-a may monitor for occurrences of the one or more latency events during a duration of the second checkpoint (e.g., according to the periodicity or the second periodicity). The memory system 110-a may adjust the values of the counters to store a quantity of the occurrences until receiving a subsequent checkpoint request.

At 260, a checkpoint request may be communicated. For example, the host system 105-a may transmit the checkpoint request to the memory system 110-a. In some cases, the host system 105-a may transmit the checkpoint request in response to the timer (e.g., set at 250) expiring, which may correspond to a periodic occurrence of the checkpoint request. The checkpoint request may include a second command for the memory system 110-a to transmit the data stored to the one or more logs of the memory system 110-a during the second checkpoint. For example, the data may include the values of the one or more counters, and the checkpoint request may request the values of the one or more counters from the memory system 110-a. In some cases, the checkpoint request may be an example of a vendor unique command.

At 265, data may be reported. For example, the memory system 110-a may report (e.g., transmit) the data stored to the one or more logs of the memory system in response to the checkpoint request and in accordance with the periodicity or the second periodicity (e.g., if indicated at 235). The data may include the values of the one or more counters, and may be an example of debug information for the memory system that is associated with the one or more latency events. In some cases, the report may be an example of a vendor unique (VU) message or command.

At 270, the host system 105-a may append the data received at 265 with the data received at 230 (e.g., appending the second checkpoint data to previous checkpoint data). Such techniques may further support the host system building a correlation between latency at the memory system 110-a and critical event occurrences at the memory system 110-a.

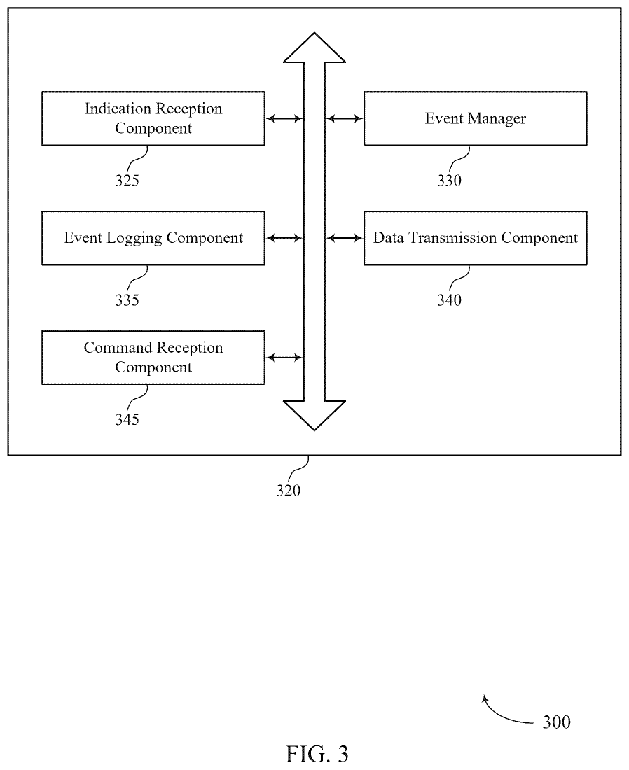

FIG. 3 shows a block diagram 300 of a memory system 320 that supports debug reporting by a memory system in accordance with examples as disclosed herein. The memory system 320 may be an example of aspects of a memory system as described with reference to FIGS. 1 through 2. The memory system 320, or various components thereof, may be an example of means for performing various aspects of debug reporting by a memory system as described herein. For example, the memory system 320 may include an indication reception component 325, an event manager 330, an event logging component 335, a data transmission component 340, a command reception component 345, or any combination thereof. Each of these components, or components of subcomponents thereof (e.g., one or more processors, one or more memories), may communicate, directly or indirectly, with one another (e.g., via one or more buses).

The indication reception component 325 may be configured as or otherwise support a means for receiving an indication of a periodicity for reporting data stored to one or more logs of the memory system, the data associated with one or more latency events of the memory system. The event manager 330 may be configured as or otherwise support a means for determining, during a duration associated with the periodicity, an occurrence of the one or more latency events in accordance with receiving the indication of the periodicity for reporting the data stored to the one or more logs of the memory system. The event logging component 335 may be configured as or otherwise support a means for adjusting a value of a counter in accordance with the one or more latency events in response to determining the one or more latency events. The data transmission component 340 may be configured as or otherwise support a means for transmitting the data stored to the one or more logs of the memory system in accordance with the periodicity and with adjusting the value of the counter.

In some examples, the command reception component 345 may be configured as or otherwise support a means for receiving a command for transmitting the data stored to the one or more logs of the memory system in accordance with the periodicity, where transmitting the data is in response to receiving the command.

In some examples, the command includes a vendor unique command.

In some examples, the event logging component 335 may be configured as or otherwise support a means for resetting the value of the counter in response to transmitting the data stored to the one or more logs of the memory system.

In some examples, the data includes debug information for the memory system and is associated with the one or more latency events.

In some examples, the event logging component 335 may be configured as or otherwise support a means for determining, during the duration, an occurrence of one or more second latency events in accordance with receiving the indication of the periodicity for reporting the data stored to the one or more logs of the memory system. In some examples, the event logging component 335 may be configured as or otherwise support a means for adjusting a value of a second counter in accordance with the one or more second latency events in response to determining the one or more second latency events. In some examples, the data transmission component 340 may be configured as or otherwise support a means for transmitting the data stored to the one or more logs of the memory system in accordance with the periodicity and adjusting the value of the second counter, where the data is further associated with the one or more second latency events.

In some examples, the counter is associated with read operations or write operations performed by the memory system. In some examples, the second counter is associated with a different type of operation as the counter.

In some examples, the indication reception component 325 may be configured as or otherwise support a means for receiving an indication of a second periodicity for reporting the data stored to one or more logs of the memory system.

In some examples, the event logging component 335 may be configured as or otherwise support a means for determining, during a second duration associated with the second periodicity, an occurrence of the one or more latency events in accordance with receiving the indication of the second periodicity for reporting the data stored to the one or more logs of the memory system. In some examples, the event logging component 335 may be configured as or otherwise support a means for adjusting a value of a third counter in accordance with the one or more latency events in response to determining the one or more latency events. In some examples, the data transmission component 340 may be configured as or otherwise support a means for transmitting the data stored to the one or more logs of the memory system in accordance with the second periodicity and adjusting the value of the third counter.

In some examples, the value of the counter is adjusted for each occurrence of the one or more latency events.

In some examples, the data stored to the one or more logs of the memory system is transmitted in accordance with the periodicity when the value of the counter reaches an overflow value prior to an end of the duration.

In some examples, the one or more latency events are associated with a delay in performing a respective operation at the memory system.

In some examples, the data includes the value of the counter.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

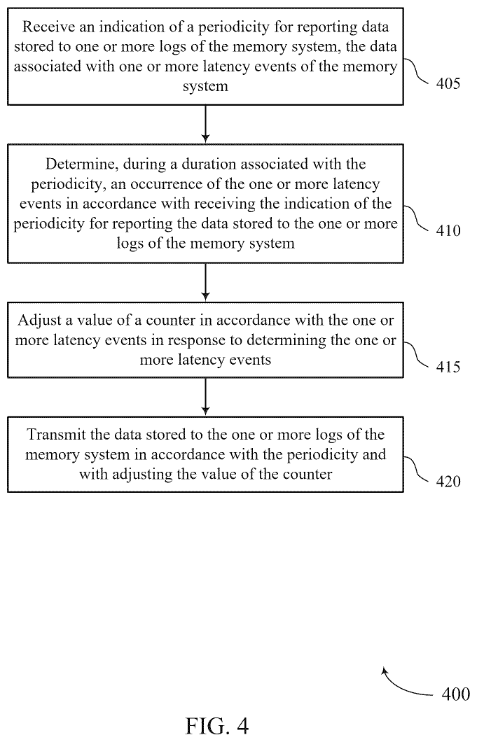

FIG. 4 shows a flowchart illustrating a method 400 that supports debug reporting by a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving an indication of a periodicity for reporting data stored to one or more logs of the memory system, the data associated with one or more latency events of the memory system. In some examples, aspects of the operations of 405 may be performed by an indication reception component 325 as described with reference to FIG. 3.

At 410, the method may include determining, during a duration associated with the periodicity, an occurrence of the one or more latency events in accordance with receiving the indication of the periodicity for reporting the data stored to the one or more logs of the memory system. In some examples, aspects of the operations of 410 may be performed by an event manager 330 as described with reference to FIG. 3.

At 415, the method may include adjusting a value of a counter in accordance with the one or more latency events in response to determining the one or more latency events. In some examples, aspects of the operations of 415 may be performed by an event logging component 335 as described with reference to FIG. 3.

At 420, the method may include transmitting the data stored to the one or more logs of the memory system in accordance with the periodicity and with adjusting the value of the counter. In some examples, aspects of the operations of 420 may be performed by a data transmission component 340 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving an indication of a periodicity for reporting data stored to one or more logs of the memory system, the data associated with one or more latency events of the memory system; determining, during a duration associated with the periodicity, an occurrence of the one or more latency events in accordance with receiving the indication of the periodicity for reporting the data stored to the one or more logs of the memory system; adjusting a value of a counter in accordance with the one or more latency events in response to determining the one or more latency events; and transmitting the data stored to the one or more logs of the memory system in accordance with the periodicity and with adjusting the value of the counter.
Aspect 2: The method, apparatus, or non-transitory computer-readable medium of aspect 1, further including operations, features, circuitry, logic, means, or instructions, or any combination thereof for receiving a command for transmitting the data stored to the one or more logs of the memory system in accordance with the periodicity, where transmitting the data is in response to receiving the command.
Aspect 3: The method, apparatus, or non-transitory computer-readable medium of aspect 2, where the command includes a vendor unique command.
Aspect 4: The method, apparatus, or non-transitory computer-readable medium of any of aspects 1 through 3, further including operations, features, circuitry, logic, means, or instructions, or any combination thereof for resetting the value of the counter in response to transmitting the data stored to the one or more logs of the memory system.
Aspect 5: The method, apparatus, or non-transitory computer-readable medium of any of aspects 1 through 4, where the data includes debug information for the memory system and is associated with the one or more latency events.
Aspect 6: The method, apparatus, or non-transitory computer-readable medium of any of aspects 1 through 5, further including operations, features, circuitry, logic, means, or instructions, or any combination thereof for determining, during the duration, an occurrence of one or more second latency events in accordance with receiving the indication of the periodicity for reporting the data stored to the one or more logs of the memory system; adjusting a value of a second counter in accordance with the one or more second latency events in response to determining the one or more second latency events; and transmitting the data stored to the one or more logs of the memory system in accordance with the periodicity and adjusting the value of the second counter, where the data is further associated with the one or more second latency events.
Aspect 7: The method, apparatus, or non-transitory computer-readable medium of aspect 6, where the counter is associated with read operations or write operations performed by the memory system and the second counter is associated with a different type of operation as the counter.
Aspect 8: The method, apparatus, or non-transitory computer-readable medium of any of aspects 1 through 7, further including operations, features, circuitry, logic, means, or instructions, or any combination thereof for receiving an indication of a second periodicity for reporting the data stored to one or more logs of the memory system.
Aspect 9: The method, apparatus, or non-transitory computer-readable medium of aspect 8, further including operations, features, circuitry, logic, means, or instructions, or any combination thereof for determining, during a second duration associated with the second periodicity, an occurrence of the one or more latency events in accordance with receiving the indication of the second periodicity for reporting the data stored to the one or more logs of the memory system; adjusting a value of a third counter in accordance with the one or more latency events in response to determining the one or more latency events; and transmitting the data stored to the one or more logs of the memory system in accordance with the second periodicity and adjusting the value of the third counter.
Aspect 10: The method, apparatus, or non-transitory computer-readable medium of any of aspects 1 through 9, where the value of the counter is adjusted for each occurrence of the one or more latency events.
Aspect 11: The method, apparatus, or non-transitory computer-readable medium of any of aspects 1 through 10, where the data stored to the one or more logs of the memory system is transmitted in accordance with the periodicity when the value of the counter reaches an overflow value prior to an end of the duration.
Aspect 12: The method, apparatus, or non-transitory computer-readable medium of any of aspects 1 through 11, where the one or more latency events are associated with a delay in performing a respective operation at the memory system.
Aspect 13: The method, apparatus, or non-transitory computer-readable medium of any of aspects 1 through 12, where the data includes the value of the counter.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a periodicity for reporting data stored to one or more logs of the memory system, the data associated with one or more latency events of the memory system;
determine, during a duration associated with the periodicity, an occurrence of the one or more latency events in accordance with receiving the indication of the periodicity for reporting the data stored to the one or more logs of the memory system;
adjust a value of a counter in accordance with the one or more latency events in response to determining the one or more latency events; and
transmit the data stored to the one or more logs of the memory system in accordance with the periodicity and with adjusting the value of the counter.

2. The memory system of claim 1, wherein the processing circuitry is further configured to cause the memory system to:
receive a command for transmitting the data stored to the one or more logs of the memory system in accordance with the periodicity, wherein transmitting the data is in response to receiving the command.

3. The memory system of claim 2, wherein the command comprises a vendor unique command.

4. The memory system of claim 1, wherein the processing circuitry is further configured to cause the memory system to:
reset the value of the counter in response to transmitting the data stored to the one or more logs of the memory system.

5. The memory system of claim 1, wherein the data comprises debug information for the memory system and is associated with the one or more latency events.

6. The memory system of claim 1, wherein the processing circuitry is further configured to cause the memory system to:
determine, during the duration, an occurrence of one or more second latency events in accordance with receiving the indication of the periodicity for reporting the data stored to the one or more logs of the memory system;
adjust a value of a second counter in accordance with the one or more second latency events in response to determining the one or more second latency events; and
transmit the data stored to the one or more logs of the memory system in accordance with the periodicity and adjusting the value of the second counter, wherein the data is further associated with the one or more second latency events.

7. The memory system of claim 6, wherein:
the counter is associated with read operations or write operations performed by the memory system, and
the second counter is associated with a different type of operation as the counter.

8. The memory system of claim 1, wherein the processing circuitry is further configured to cause the memory system to:
receive an indication of a second periodicity for reporting the data stored to one or more logs of the memory system.

9. The memory system of claim 8, wherein the processing circuitry is further configured to cause the memory system to:
determine, during a second duration associated with the second periodicity, an occurrence of the one or more latency events in accordance with receiving the indication of the second periodicity for reporting the data stored to the one or more logs of the memory system;
adjust a value of a third counter in accordance with the one or more latency events in response to determining the one or more latency events; and
transmit the data stored to the one or more logs of the memory system in accordance with the second periodicity and adjusting the value of the third counter.

10. The memory system of claim 1, wherein the value of the counter is adjusted for each occurrence of the one or more latency events.

11. The memory system of claim 1, wherein the data stored to the one or more logs of the memory system is transmitted in accordance with the periodicity when the value of the counter reaches an overflow value prior to an end of the duration.

12. The memory system of claim 1, wherein the one or more latency events are associated with a delay in performing a respective operation at the memory system.

13. The memory system of claim 1, wherein the data comprises the value of the counter.

14. A method by a memory system, comprising:
receiving an indication of a periodicity for reporting data stored to one or more logs of the memory system, the data associated with one or more latency events of the memory system;
determining, during a duration associated with the periodicity, an occurrence of the one or more latency events in accordance with receiving the indication of the periodicity for reporting the data stored to the one or more logs of the memory system;
adjusting a value of a counter in accordance with the one or more latency events in response to determining the one or more latency events; and
transmitting the data stored to the one or more logs of the memory system in accordance with the periodicity and with adjusting the value of the counter.

15. The method of claim 14, further comprising:
receiving a command for transmitting the data stored to the one or more logs of the memory system in accordance with the periodicity, wherein transmitting the data is in response to receiving the command.

16. The method of claim 15, wherein the command comprises a vendor unique command.

17. The method of claim 14, further comprising:
resetting the value of the counter in response to transmitting the data stored to the one or more logs of the memory system.

18. The method of claim 14, wherein the data comprises debug information for the memory system and is associated with the one or more latency events.

19. The method of claim 14, further comprising:
determining, during the duration, an occurrence of one or more second latency events in accordance with receiving the indication of the periodicity for reporting the data stored to the one or more logs of the memory system;
adjusting a value of a second counter in accordance with the one or more second latency events in response to determining the one or more second latency events; and
transmitting the data stored to the one or more logs of the memory system in accordance with the periodicity and adjusting the value of the second counter, wherein the data is further associated with the one or more second latency events.

20. The method of claim 19, wherein:
the counter is associated with read operations or write operations performed by the memory system, and
the second counter is associated with a different type of operation as the counter.

21. The method of claim 14, further comprising:
receiving an indication of a second periodicity for reporting the data stored to one or more logs of the memory system.

22. The method of claim 21, further comprising:
determining, during a second duration associated with the second periodicity, an occurrence of the one or more latency events in accordance with receiving the indication of the second periodicity for reporting the data stored to the one or more logs of the memory system;
adjusting a value of a third counter in accordance with the one or more latency events in response to determining the one or more latency events; and
transmitting the data stored to the one or more logs of the memory system in accordance with the second periodicity and adjusting the value of the third counter.

23. The method of claim 14, wherein the value of the counter is adjusted for each occurrence of the one or more latency events.

24. The method of claim 14, wherein the data stored to the one or more logs of the memory system is transmitted in accordance with the periodicity when the value of the counter reaches an overflow value prior to an end of the duration.

25. The method of claim 14, wherein the one or more latency events are associated with a delay in performing a respective operation at the memory system.
